(19) United States
(12) Patent Application Publication
(10) Pub. No.: US 2012/0104965 A1
(43) Pub. Date: May 3, 2012

(54) CURRENT RINGING FILTER FOR DIMMABLE COMPACT FLUORESCENT LAMPS

(75) Inventors: Jacint Gergely, Budapest (HU); Gabor Schmidt, Budapest (HU); Mate Krejcarek, Budapest (HU); Laszlo Petras, Budapest (HU); Peter Vigh, Budapest (HU)

(73) Assignee: General Electric Company

(21) Appl. No.: 12/915,834

(22) Filed: Oct. 29, 2010

(51) Int. Cl. H05B 41/36

(52) U.S. Cl. 315/291

(57) ABSTRACT

A ballast or drive circuit is located between a dimmer switch and at least one light source or lamp. The ballast includes an electromagnetic interference (EMI) filter operatively disposed between the dimmer switch and the at least one lamp. The EMI filter includes an inductor. A low pass filter, preferably an inductor, is serially connected to the inductor of the EMI filter and situated between the dimmer switch and EMI filter for addressing currency ringing, reducing high current peaks, and decreasing flickering that would otherwise result with multiple light sources when the lamp is turned on.

### BACKGROUND OF THE DISCLOSURE

The disclosure relates to lighting systems and more particularly to drivers or ballasts for powering light sources such as LED arrays, fluorescent or other discharge light sources or lamps (e.g., HID). Many lighting system installations include a user-operated control unit, such as a wall-mounted switch or dimmer control, allowing controlled operation of a light source that is mounted remotely from the control device.

A high in-rush of current or high current peaks to the light source(s) (e.g., compact fluorescent lamps or CFLs) is a common problem association with a dimmable CFL ballast when the lamp is just turned “on” or when the dimmer operates more than one dimmable lamp.

Another problem relates to cross-impact between multiple lamps such as in a chandelier and the need to limit flickering.

Still another problem is associated with current ringing when one or more dimmable lamps are connected to a dimmer. Current ringing or ripple is an undesired current oscillation that may occur in response to a sudden change in the current, such as turning the lamp “on”.

Therefore a need exists to address one or more of these problems in a simple, effective, and low cost manner, and that advantageously permits dimmable lamps such as CFLs to be used with lower cost dimmers.

### SUMMARY OF THE DISCLOSURE

An improved ballast or driver circuit is provided for one or more dimmable light sources such as a compact fluorescent lamp or CFL, discharge lamp, or LED array.

In a preferred arrangement, a ballast circuit located between an associated dimmer switch and at least one associated lamp includes an electromagnetic interference (EMI) filter operatively disposed between the associated dimmer switch and the at least one associated lamp. The EMI filter includes an inductor. A low pass filter interfaces between the EMI filter and the associated dimmer switch for reducing high current peaks when the at least one lamp is turned on.

The low pass filter is preferably in series with the EMI filter, particularly the low pass filter is in series with the inductor of the EMI filter.

The EMI filter further includes first and second capacitors in parallel relation with the at least one associated lamp, where the low pass filter is an inductor.

A method of reducing current ringing in a lamp circuit includes providing an electromagnetic interference (EMI) filter between an associated dimming switch and an associated light source and adding an inductor between the EMI filter and the associated dimming switch.

The preferred method includes using a series inductance, i.e., placing the inductor that acts as a low pass filter in series with an inductor of the EMI filter.

The method further includes locating the inductor between the dimmer switch and upstream of the EMI filter.

One benefit is the reduction or substantial elimination of high in-rush current to the lamp(s).

A further advantage resides in the ability to eliminate current ringing.

Yet another advantage is associated with decreasing the cross-impact between individual lamps operated in a multiple light source environment such as a chandelier, and thereby reducing flickering.

Still other features and benefits of the disclosure may be realized upon reading and understanding the following detailed description.

### BRIEF DESCRIPTION OF THE DRAWINGS

FIG. 1 is a schematic diagram illustrating an exemplary lighting ballast or driver having an AC input and that incorporates a current ringing filter of the present disclosure.

FIG. 2 is a schematic representation of the current ringing issue associated with prior ballast arrangements.

FIG. 3 is a schematic representation of elimination or reducing the current ringing issue in the ballast circuit of FIG. 1 with the inclusion of a current ringing filter.

### DETAILED DESCRIPTION

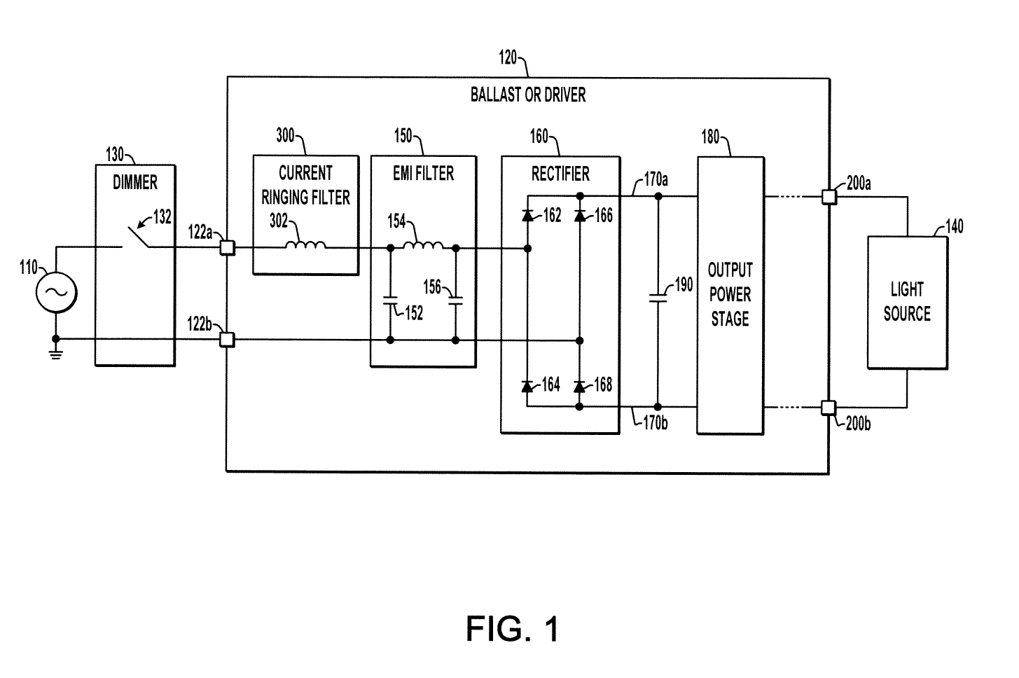

FIG. 1 illustrates an exemplary lighting system 100 including an AC power source 110 coupled with a ballast or driver circuit 120 through a light source control device such as a dimmer 130 having a dimmer switch 132. The ballast 120 is operable in response to power provided from the source 110 to drive one or more light sources 140, such as one or more LED arrays, fluorescent lamps, or other discharge lamps such as HID lamps, etc. The exemplary ballast 120 is operatively associated with or coupled with the AC source 110 via a ballast input which in the preferred arrangement includes first and second ballast input terminals 122a, 122b for receiving AC input power.

An electromagnetic interference (EMI) filter 150 is coupled to the input terminals 122a, 122b. In this example, the EMI filter 150 includes a C-L-C filter circuit with an input parallel capacitance 152, a series inductance or inductor 154 and a further parallel capacitance 156.

A rectifier portion 160 of the ballast is coupled with the input 122 (e.g., through the EMI filter 150 in the illustrated example) and includes one or more passive or active rectifiers (e.g., diodes) to convert the AC input power to provide rectifier DC output power. The rectifier portion of the ballast is shown as a passive full bridge rectifier 160 constructed using diodes 162, 164, 166, 168 forming a rectifier bridge circuit receiving the AC input power through the EMI filter 150 and providing rectifier DC output power at rectifier output terminals 170a, 170b.

The ballast 120 further includes an output power stage 180 having one or more power conversion circuits (not shown) operatively coupled with the rectifier output teiiiiinals 170a, 170b to convert the rectifier DC output power to provide ballast or driver output power to the light source(s) 140. A DC bus capacitance 190 is coupled between the output of the rectifier 170a, 170b and the output power stage 180.

In certain embodiments, the ballast 120 is an LED driver circuit, with the output power stage 180 having a DC to DC converter circuit coupled with the rectifier output terminals 170a and 170b to convert the rectifier DC output power to provide DC driver output power to at least one LED light source 140. In other embodiments, the apparatus ballast or driver circuit 120 is a fluorescent lamp ballast, where the output power stage 180 includes a DC to DC converter as well as an inverter providing AC output power to one or more fluorescent light sources 140 via output terminals 200a and 200b. The DC to DC converter may be omitted in certain ballast implementations, with the inverter directly converting the output of the rectifier 160 to provide AC output power to the light source(s) 140.

To this above-described ballast is added a low pass, current ringing and transient filter 300 that is disposed between the AC inputs 122a, 122b to the ballast and the EMI filter. More specifically, the current ringing filter 300 is a part of the ballast and located upstream of the EMI filter between the dimmer 130 and the EMI filter. The current ringing filter 300 is an inductor 302 that is disposed in series with the inductor 154 of the EMI filter, In a dimmable lighting arrangement, ringing results in the input current, i.e., high frequency ringing occurs in the current line when the dimmer switch 132 is closed. There is a need for cooperation between the dimmer and the lamp so that the dimmer and the lamp input do not interfere with one another. The current ringing filter is a series inductor and as one skilled in the art will appreciate, has a value or is sized dependent on the value of the EMI filter.

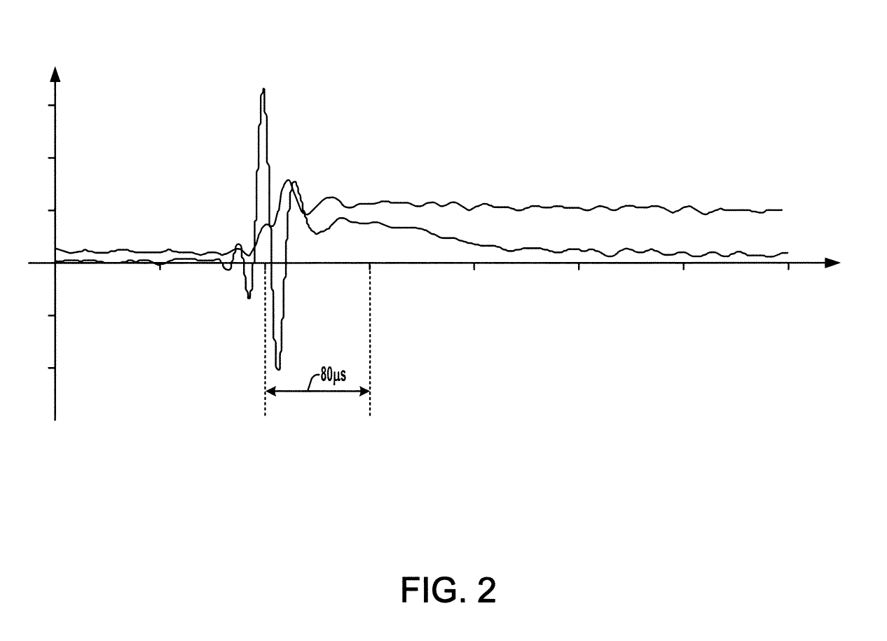

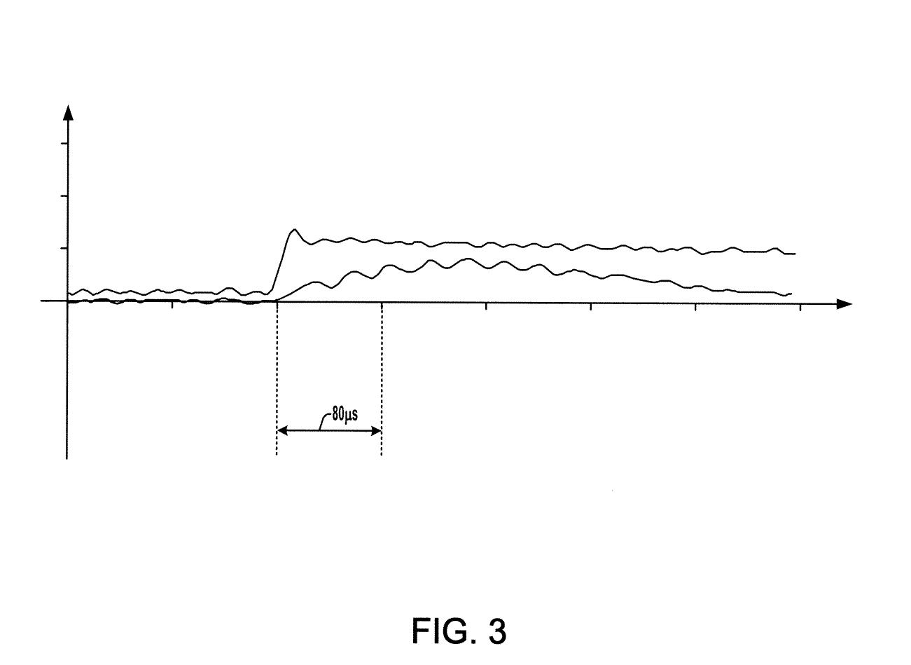

FIGS. 2 (without current ringing filter) and 3 (with current ringing filter) illustrate data showing the impact of using the current ringing filter and thereby reducing the high current peaks evident in the arrangement of FIG. 2 and not found in FIG. 3. Likewise, the undesired current oscillation is minimized with the addition of the serially connected inductor 302 between the EMI filter 150 and the dimmer 130 (and more specifically upstream of and in series with the EMI filter inductor 154).

The above examples are merely illustrative of several possible embodiments of various aspects of the present disclosure, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, processor-executed software, or combinations thereof, which performs the specified function of the described component (i.e., that is functionally equivalent), even though not structurally equivalent to the disclosed structure which performs the function in the illustrated implementations of the disclosure. In addition, although a particular feature of the disclosure may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”. The invention has been described with reference to the preferred embodiments. Obviously, modifications and alterations will occur to others upon reading and understanding the preceding detailed description. It is intended that the invention be construed as including all such modifications and alterations.

The following is claimed:

1. A ballast circuit interposed between an associated dimmer switch and at least one associated lamp comprising:
an electromagnetic interference (EMI) filter operatively disposed between the associated dimmer switch and the at least one associated lamp, the EMI filter including an inductor; and
a low pass filter interfacing between the EMI filter and the associated dimmer switch for reducing high current peaks when the at least one lamp is turned on.

2. The ballast circuit of claim 1 wherein the low pass filter is in series with the EMI filter.

3. The ballast circuit of claim 2 wherein the low pass filter is in series with the inductor of the EMI filter.

4. The ballast circuit of claim 1 wherein the EMI filter further includes first and second capacitors in parallel relation with the at least one associated lamp.

5. The ballast circuit of claim 1 wherein the low pass filter is an inductor.

6. The ballast circuit of claim 5 wherein the inductor is in series with the EMI filter.

7. The ballast circuit of claim 5 wherein the inductor is in series with the inductor of the EMI filter.

8. A lamp ballast circuit that selectively receives power from an associated dimming switch comprising:
an electromagnetic intefference (EMI) filter including an inductor operatively associated with an associated light source; and
a low pass, current ringing and transient filter upstream of the EMI filter and in series connection with the EMI inductor.

9. The lamp ballast of claim 8 wherein the low pass filter is an inductor.

10. A method of reducing current ringing in a lamp circuit comprising:
providing an electromagnetic interference (EMI) filter between an associated dimming switch and an associated light source; and
adding an inductor between the EMI filter and the associated dimming switch.

11. The method of claim 10 wherein the adding step includes serially connecting the inductor. with the EMI filter.

12. The method of claim 11 wherein the EMI filter includes a second inductor and the method further comprises serially connecting the inductor to the second inductor.
